(19) United States
(12) Patent Application Publication
(10) Pub. No.: US 2019/0012707 A1
(43) Pub. Date: Jan. 10, 2019

(54) Systems, Devices, And Methods Thereof For Fan Interaction And Sponsor Participation

(71) Applicant: Mark Walker, Austin, TX (US)

(72) Inventor: Mark Walker, Austin, TX (US)

(21) Appl. No.: 16/029,303

(22) Filed: Jul. 6, 2018

Related U.S. Application Data
(60) Provisional application No. 62/529,828, filed on Jul. 7, 2017.

(51) Int. Cl. G06Q 30/02; G06F 17/30; G06Q 50/00

(52) U.S. Cl. CPC G06Q 30/0275; G06Q 50/01; G06Q 30/0226; G06F 17/30876

(57) ABSTRACT

Provided herein is a system including, in some embodiments, a user-interaction module and a sponsor module of at least one mobile computing device. The user-interaction module can be configured to display on a touchscreen display screen of the device moment-related information corresponding to one or more moments in a performance of an entity, an occurrence of an event, or a combination thereof, the one or more moments selected from server-auctioned future moments, present moments, and past moments. The user-interaction module can also be configured to display user-interaction information configured to facilitate user interaction with the one or more server-auctioned moments on the display screen of the device. The sponsor module can be configured to display one or more sponsors of the performance of the entity, the occurrence of the event, or the combination thereof during the one or more server-auctioned moments on the display screen of the device.

### PRIORITY

This application claims the benefit of U.S. Provisional Patent Application No. 62/529,828, filed Jul. 7, 2017, which is hereby incorporated by reference herein in its entirety.

### BACKGROUND

Sports stars, entertainers, and the like and their performances can benefit from fan participation. In addition, fans and their experiences can be enhanced by such performances. Provided herein are systems, devices, and methods that provide further benefits, enhancements, or both to sports stars, entertainers, and the like, their fans, other parties, or a combination thereof.

### SUMMARY

Provided herein is a system including, in some embodiments, a client-based user-interaction module and a client-based sponsor module stored in one or more non-volatile memories of at least one mobile computing device and a server-based user-interaction module and a server-based auction module stored in one or more non-volatile memories of a server system. The client-based user-interaction module upon execution by one or more processors of the at least one device can be configured to display on a touchscreen display screen of the at least one device moment-related information corresponding to one or more moments in a performance of an entity, an occurrence of an event, or a combination thereof, the one or more moments selected from future moments, present moments, and past moments in the performance of the entity, the occurrence of the event, or the combination thereof. Also, upon execution, the client-based user-interaction module can be configured to display user-interaction information configured to facilitate user interaction with the one or more moments on the display screen of the at least one device. The client-based sponsor module upon execution by the one or more processors of the at least one device can be configured to display one or more sponsors of the performance of the entity, the occurrence of the event, or the combination thereof during the one or more moments on the display screen of the at least one device. The server-based user-interaction module upon execution by one or more processors of the server system can be configured to track in one or more databases an individual user interaction for up to each of a number of users and a collective user interaction for up to a total number of the users. The server-based auction module upon execution by the one or more processors of the server system can be configured to auction to the one or more sponsors display-screen screen time in time frames leading into the future moments, during the present moments, or following past moments based upon one or more criteria including one or more characteristics of the moments themselves, the individual or collective user interaction, or a combination thereof.

In some embodiments, the system can further include a server-based award module. The server-based award module upon execution by the one or more processors of the server system can be configured to award one or more awards for the individual user interaction or the collective user interaction for any of the number of users, the one or more awards selected from points, rewards, and coupons.

In some embodiments, the one or more criteria can include a collective intensity of the collective user interaction as algorithmically determined from client-based user-interaction-module data from touchscreen display-screen tapping on a number of mobile computing devices.

In some embodiments, the one or more criteria can include a collective intensity of the collective user interaction as algorithmically determined from sensor data from a number of mobile computing devices. The sensor data from one or more sensors can be selected from accelerometers, gyroscopes, magnetometers, proximity sensors, light sensors, thermometers, air-humidity sensors, microphones, and cameras.

In some embodiments, the sensor data can include sensor data resulting from waving the number of devices, swinging the number of devices, shaking the number of devices, or a combination thereof.

In some embodiments, the one or more criteria can include a collective intensity of the collective user interaction as algorithmically determined from client-based user-interaction-module data from touchscreen display-screen tapping on a number of mobile computing devices, sensor data from the number of devices, or a combination thereof. The sensor data from one or more sensors can be selected from accelerometers, gyroscopes, magnetometers, proximity sensors, light sensors, thermometers, air-humidity sensors, microphones, and cameras resulting from waving the number of devices, swinging the number of devices, shaking the number of devices, or a combination thereof.

In some embodiments, the one or more criteria can include an amount of users in the collective user interaction as algorithmically determined from a number of mobile computing devices.

In some embodiments, the one or more criteria can include an amount of users in a particular location in the collective user interaction as algorithmically determined from a number of unique global positioning system (“GPS”) coordinates.

In some embodiments, the one or more characteristics of the moments themselves can be a relation to a particular group, a particular entertainer, a particular public figure, a particular team, a particular player, or a combination thereof.

In some embodiments, the event can be a baseball game, a football game, a soccer game, a basketball game, a concert performance, or a political speech.

In some embodiments, the event can be a baseball game and the one or more moments can be selected from any offensive-player moment and any defensive player moment.

In some embodiments, the event can be a baseball game, the future moment can be a first batter on-deck awaiting a time at bat, the present moment can be a second batter at bat, and the past moment can be subsequent to a third batter getting a hit, hitting a home run, getting hit by a pitch, or striking out.

In some embodiments, the event can be a football game and the one or more moments can be selected from a play, a power play, a drive, a down, a touchdown, a catch, a long run, a sack, a goal-line stand, and a penalty kick.

In some embodiments, the event can be a soccer game and the one or more moments can be selected from a goal, a kick off, a penalty kick, a tackle, and a sliding tackle.

In some embodiments, the event can be a basketball game and the one or more moments can be selected from a field goal, a three-pointer field goal, a slam dunk, an alley-oop, a rebound, and an assist.

In some embodiments, the event can be a concert performance and the one or more moments can be selected from a start of a song, an end of a song, a demand by the audience for an encore, a start of an encore, and an end of the concert performance.

In some embodiments, the event can be a political speech and the one or more moments can be selected from certain words spoken, certain concepts conveyed, certain topics, and certain catch phrases spoken.

Also provided herein is a non-transitory machine-readable storage medium having stored thereon a computer program comprising a set of instructions that cause a mobile computing device to perform one or more steps when executed by one or more processors including, in some embodiments, displaying content on a touchscreen display screen of the device and communicating with a server system. Displaying the content on the touchscreen display screen of the device can include displaying by means of a client-based user-interaction module moment-related information and user-interaction information. The moment-related information can correspond to one or more moments in a performance of an entity, an occurrence of an event, or a combination thereof. The one or more moments can be selected from future moments, present moments, and past moments in the performance of the entity, the occurrence of the event, or the combination thereof. The user-interaction information can be configured to facilitate user interaction with the one or more moments. Displaying the content on the touchscreen display screen of the device can also include displaying by means of a client-based sponsor module one or more sponsors of the performance of the entity, the occurrence of the event, or the combination thereof during the one or more moments. Communicating with the server system can include communicating with a server-based user-interaction module and a server-based auction module stored in one or more non-volatile memories of the server system. The server-based user-interaction module upon execution by one or more processors of the server system can be configured to track in one or more databases one or more individual user interactions received from the client-based user-interaction module. The server-based user-interaction module can also be configured to track in the one or more databases one or more additional user interactions for additional users of a number of like mobile computing devices for a collective user interaction. The server-based auction module upon execution by the one or more processors of the server system can be configured to auction to the one or more sponsors display-screen screen time on the device in time frames leading into the future moments, during the present moments, or following past moments based upon one or more criteria. The one or more criteria can include one or more characteristics of the moments themselves, the individual user interactions, the collective user interaction, or a combination thereof.

In some embodiments, the storage medium's set of instructions can further cause the mobile computing device to perform one or more additional steps including displaying an award provided by means of a server-based award module. The server-based award module upon execution by the one or more processors of the server system can be configured to award one or more awards for the one or more individual user interactions or a device-related portion of the collective user interaction received from the client-based user-interaction module. The one or more awards can be selected from points, rewards, and coupons.

In some embodiments, the one or more criteria can include a collective intensity of the collective user interaction as algorithmically determined from client-based user-interaction-module data from touchscreen display-screen tapping on the number of like mobile computing devices including that of the display screen of the device.

In some embodiments, the one or more criteria can include a collective intensity of the collective user interaction as algorithmically determined from sensor data from the number of like mobile computing devices including that of the device, the sensor data from one or more sensors selected from accelerometers, gyroscopes, magnetometers, proximity sensors, light sensors, thermometers, air-humidity sensors, microphones, and cameras.

In some embodiments, the sensor data can include sensor data resulting from waving, swinging, or shaking the number of like mobile computing devices including the device, or a combination thereof.

In some embodiments, the one or more criteria can include a collective intensity of the collective user interaction as algorithmically determined from client-based user-interaction-module data from touchscreen display-screen tapping on the number of like mobile computing devices including that of the device, sensor data from the number of devices including that of the device, or a combination thereof. The sensor data from one or more sensors can be selected from accelerometers, gyroscopes, magnetometers, proximity sensors, light sensors, thermometers, air-humidity sensors, microphones, and cameras resulting from waving, swinging, or shaking the number of like mobile computing devices including that of the device, or a combination thereof.

In some embodiments, the one or more criteria can include an amount of users in the collective user interaction as algorithmically determined from the number of like mobile computing devices including that of the device.

In some embodiments, the one or more criteria can include an amount of users in a particular location in the collective user interaction as algorithmically determined from a number of unique GPS coordinates.

In some embodiments, the one or more characteristics of the moments themselves can be a relation to a particular group, a particular entertainer, a particular public figure, a particular team, a particular player, or a combination thereof.

In some embodiments, the event can be a baseball game, a football game, a soccer game, a basketball game, a concert performance, or a political speech.

In some embodiments, the event can be a baseball game and the one or more moments can be selected from any offensive-player moment and any defensive player moment.

In some embodiments, the event can be a baseball game, the future moment can be a first batter on-deck awaiting a time at bat, the present moment can be a second batter at bat, and the past moment can be subsequent to a third batter getting a hit, hitting a home run, getting hit by a pitch, or striking out.

In some embodiments, the event can be a football game and the one or more moments can be selected from a play, a power play, a drive, a down, a touchdown, a catch, a long run, a sack, a goal-line stand, and a penalty kick.

In some embodiments, the event can be a soccer game and the one or more moments can be selected from a goal, a kick off, a penalty kick, a tackle, and a sliding tackle.

In some embodiments, the event can be a basketball game and the one or more moments can be selected from a field goal, a three-pointer field goal, a slam dunk, an alley-oop, a rebound, and an assist.

In some embodiments, the event can be a concert performance and the one or more moments can be selected from a start of a song, an end of a song, a demand by the audience for an encore, a start of an encore, and an end of the concert performance.

In some embodiments, the event can be a political speech and the one or more moments can be selected from certain words spoken, certain concepts conveyed, certain topics, and certain catch phrases spoken.

These and other features of the concepts provided herein may be better understood with reference to the following drawings, description, and appended claims.

### DRAWINGS

FIG. 1 provides a schematic illustrating a device in accordance with some embodiments.

FIG. 2 provides a schematic illustrating a server system including one or more servers in accordance with some embodiments.

FIG. 3A provides a schematic illustrating a number of devices in communication with one or more servers in accordance with some embodiments.

FIG. 3B provides a map illustrating geolocation of a number of devices in accordance with some embodiments.

FIG. 4A provides a schematic illustrating a user interface on a display screen provided in part by a client-based user-interaction module and sponsor module in accordance with some embodiments.

FIG. 4B provides a schematic illustrating a user interface on a display screen provided in part by a client-based user-interaction module and sponsor module in accordance with some embodiments.

FIG. 5 provides a schematic illustrating a device in accordance with some embodiments.

### DESCRIPTION

Before certain concepts and some embodiments thereof are provided in greater detail, it should be understood by persons of ordinary skill in the art that the concepts and embodiments provided herein are not limiting. For example, it should be understood that one or more elements in any embodiment provided herein can vary. In view of the foregoing, one or more elements from one or more embodiments can be combined with elements of any other embodiments, substituted for elements of any other embodiments, or some combination thereof.

It should also be understood that the terminology used herein is for the purpose of describing the concepts and embodiments provided herein, and the terminology is not intended to be limiting. Unless indicated otherwise, ordinal numbers (e.g., first, second, third, etc.) are used to distinguish or identify different elements or steps respectively in a group of elements or group of steps. The ordinal numbers do not supply a serial or numerical limitation. For example, “first,” “second,” and “third” elements or steps need not necessarily appear in that order, and the embodiments need not necessarily be limited to the three elements or steps. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

Sports stars, entertainers, and the like and their performances can benefit from fan participation. In addition, fans and their experiences can be enhanced by such performances. Provided herein are systems, devices, and methods that provide further benefits, enhancements, or both to sports stars, entertainers, and the like, their fans, other parties, or a combination thereof.

For example, provided herein is a system including, in some embodiments, a user-interaction module and a sponsor module of at least one mobile computing device. The user-interaction module can be configured to display on a touchscreen display screen of the device moment-related information corresponding to one or more moments in a performance of an entity, an occurrence of an event, or a combination thereof, the one or more moments selected from server-auctioned future moments, present moments, and past moments. The user-interaction module can also be configured to display user-interaction information configured to facilitate user interaction with the one or more server-auctioned moments on the display screen of the device. The sponsor module can be configured to display one or more sponsors of the performance of the entity, the occurrence of the event, or the combination thereof during the one or more server-auctioned moments on the display screen of the device.

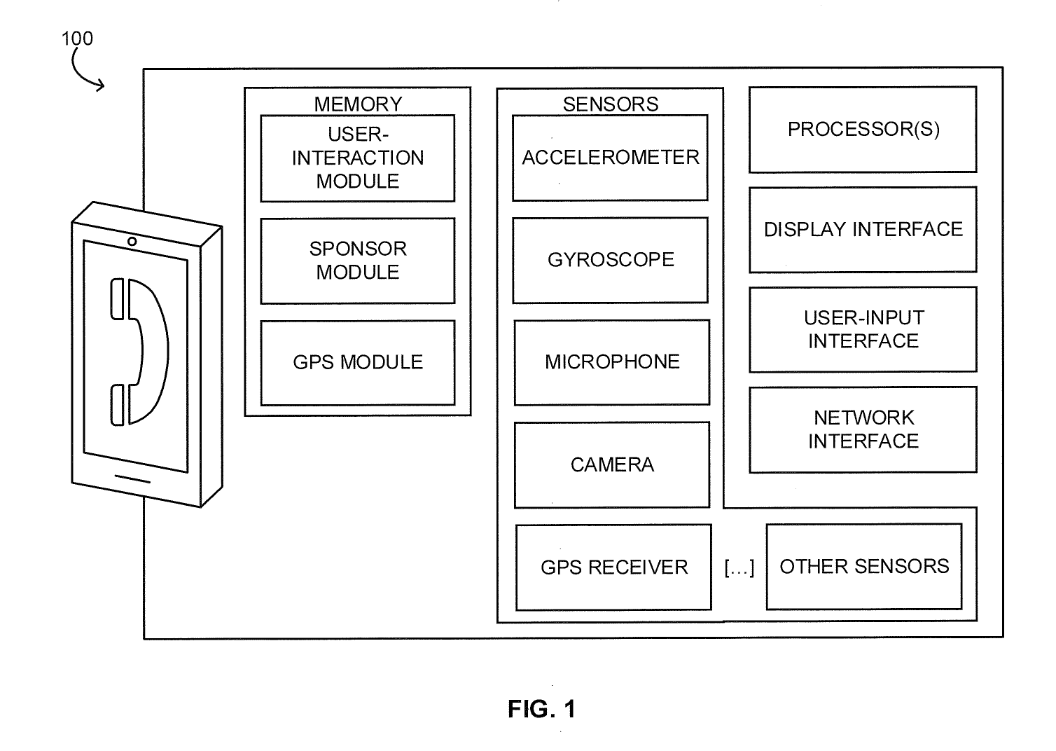

FIG. 1 provides a schematic illustrating such a device 100 in accordance with some embodiments.

As shown in FIG. 1, the device 100 can include a memory, one or more processors, one or more sensors, a display interface, a user-input interface, and a network interface. The sensors can include, but are not limited to, sensors selected from accelerometers, gyroscopes, magnetometers, proximity sensors, light sensors, thermometers, air-humidity sensors, microphones, cameras, and GPS receivers. The memory can include stored therein one or more modules selected from a user-interaction module, a sponsor module, and a GPS module.

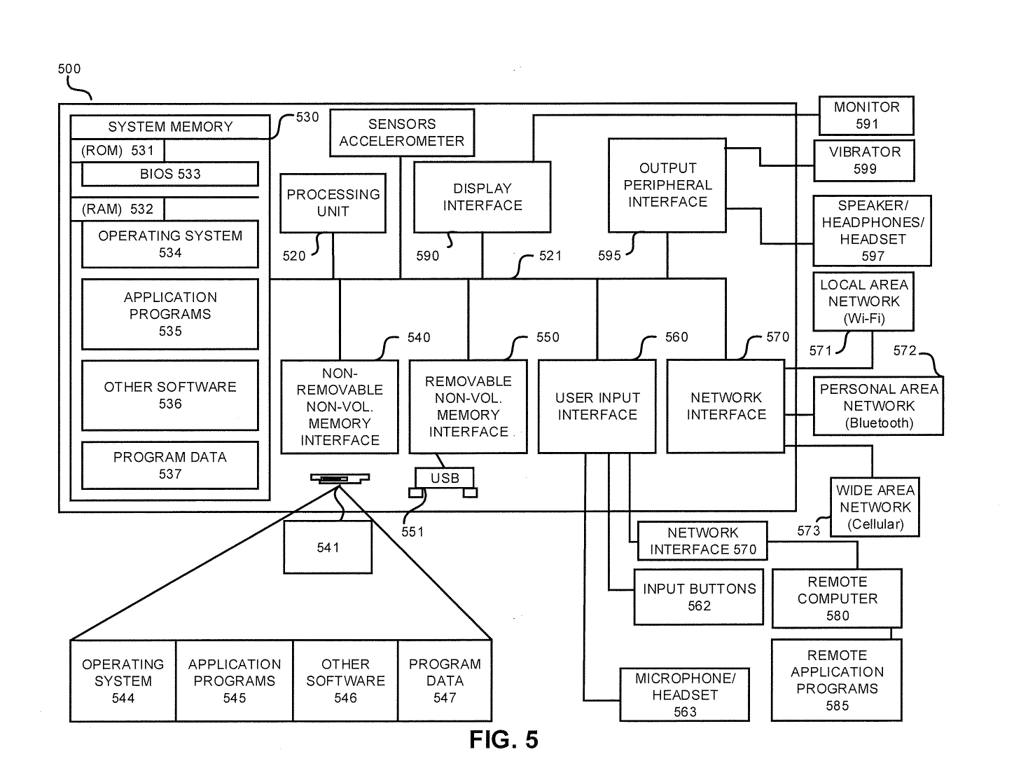

The device 100 can be a client device of a number of client devices. For example, the device 100 can be a smart phone of a number of smart phones, tablet computer, and the like. FIG. 5 provided herein below, as well as the description therefor, provides additional optional elements of the device 100 and description for how the elements of the device 100 such as the foregoing elements cooperate with each other.

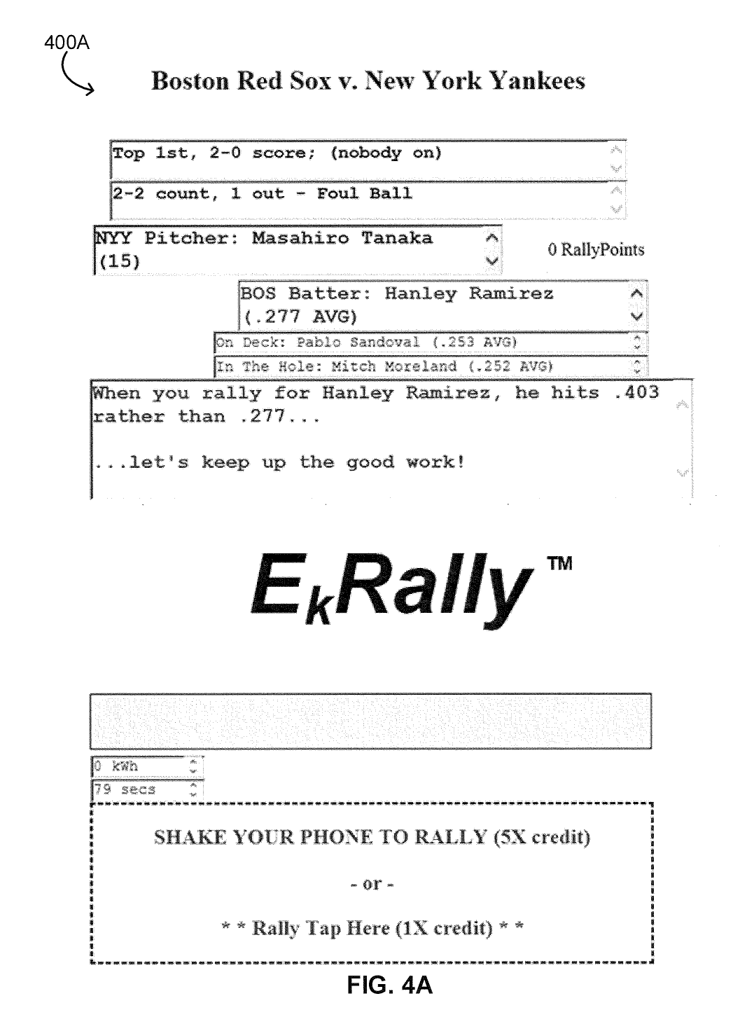

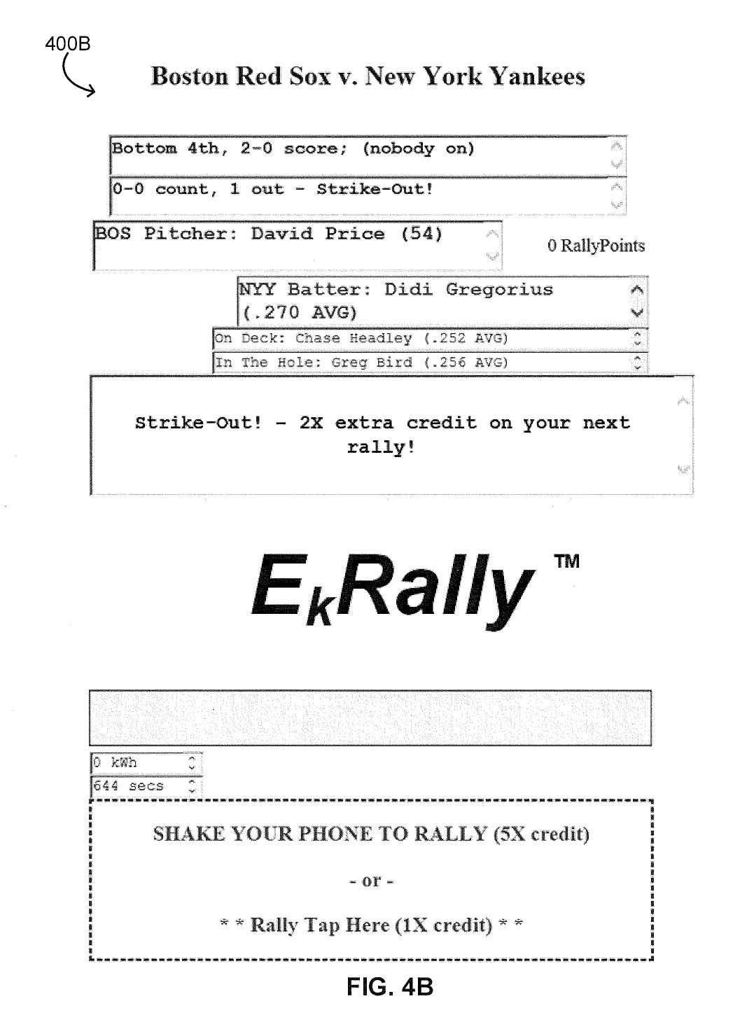

The user-interaction module of the device 100 or client-based user-interaction module upon execution by one or more processors of the device 100 can be configured to display on a touchscreen display screen of the device 100 moment-related information corresponding to one or more moments in a performance of an entity, an occurrence of an event, or a combination thereof. The one or more moments can be selected from future moments, present moments, and past moments in the performance of the entity, the occurrence of the event, or the combination thereof. (See user interfaces 400A and 400B in FIGS. 4A and 4B, respectively, for some example moments in a baseball game.) Also, upon execution, the client-based user-interaction module can be configured to display user-interaction information configured to facilitate user interaction with the one or more moments on the display screen of the at least one device. (See FIGS. 4A and 4B for some example user-interaction information configured as interactive visual elements with user-interaction instructions [e.g., touchscreen tapping], non-interactive visual elements with user-interaction instructions [e.g., swinging or shaking the device 100] to facilitate user interaction.)

The sponsor module of the device 100 or client-based sponsor module upon execution by the one or more processors of the at least one device can be configured to display one or more sponsors of the performance of the entity, the occurrence of the event, or the combination thereof during the one or more moments on the display screen of the at least one device. (See FIGS. 4A and 4B for an example sponsor, EₖRally™.)

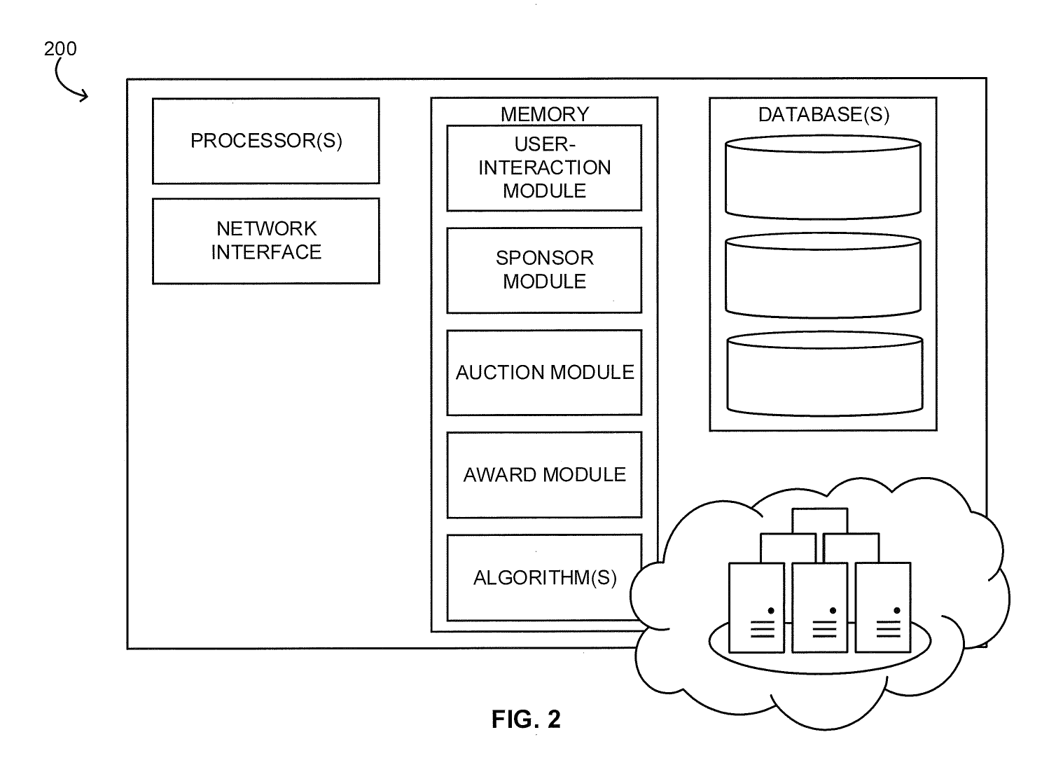

FIG. 2 provides a schematic illustrating a server system 200 including one or more servers configured to cooperate with the at least the device 100 in accordance with some embodiments.

As shown in FIG. 2, the server system 200 can include a memory, one or more processors, one or more databases, and a network interface. The memory can include stored therein one or more modules selected from a user-interaction module, a sponsor module, an auction module, an award module, a tracker, a calculator, and a GPS module.

The server system 200 can be a cloud-based system configured to cooperate with the number of client devices. FIG. 5 provided herein below, as well as the description therefor, also provides additional optional elements of the server system 200 and description for how the elements of the server system 200 such as the foregoing elements cooperate with each other.

The user-interaction module of the server system 200 or the server-based user-interaction module upon execution by one or more processors of the server system 200 can be configured to track in one or more databases an individual user interaction on a device such as the device 100 for up to each of a number of users on a number of devices and a collective user interaction for up to a total number of the users on the number of devices.

The auction module of the server system 200 or server-based auction module upon execution by the one or more processors of the server system 200 can be configured to auction to the one or more sponsors display-screen screen time in time frames leading into the future moments, during the present moments, or following past moments based upon one or more criteria including the individual or collective user interaction, one or more characteristics of the moments themselves, or a combination thereof.

The award module of the server system 200 or server-based award module upon execution by the one or more processors of the server system 200 can be configured to award one or more awards for the individual user interaction or the collective user interaction for any of the number of users, the one or more awards selected from points, rewards, and coupons.

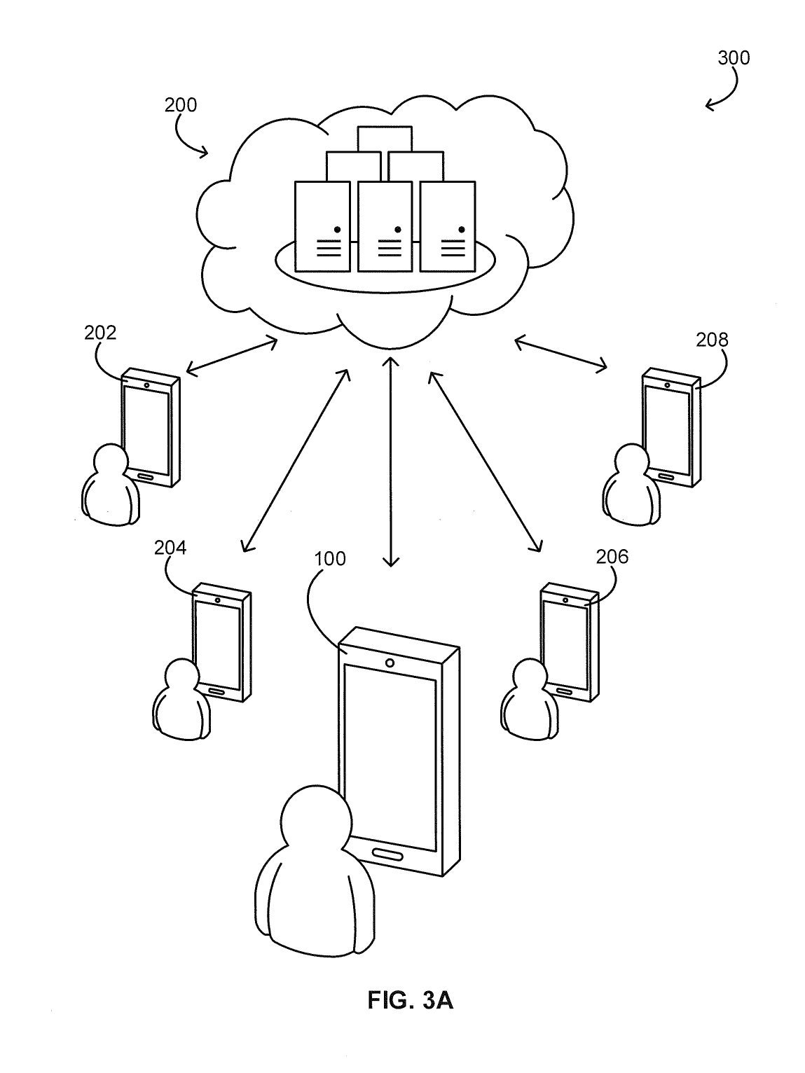

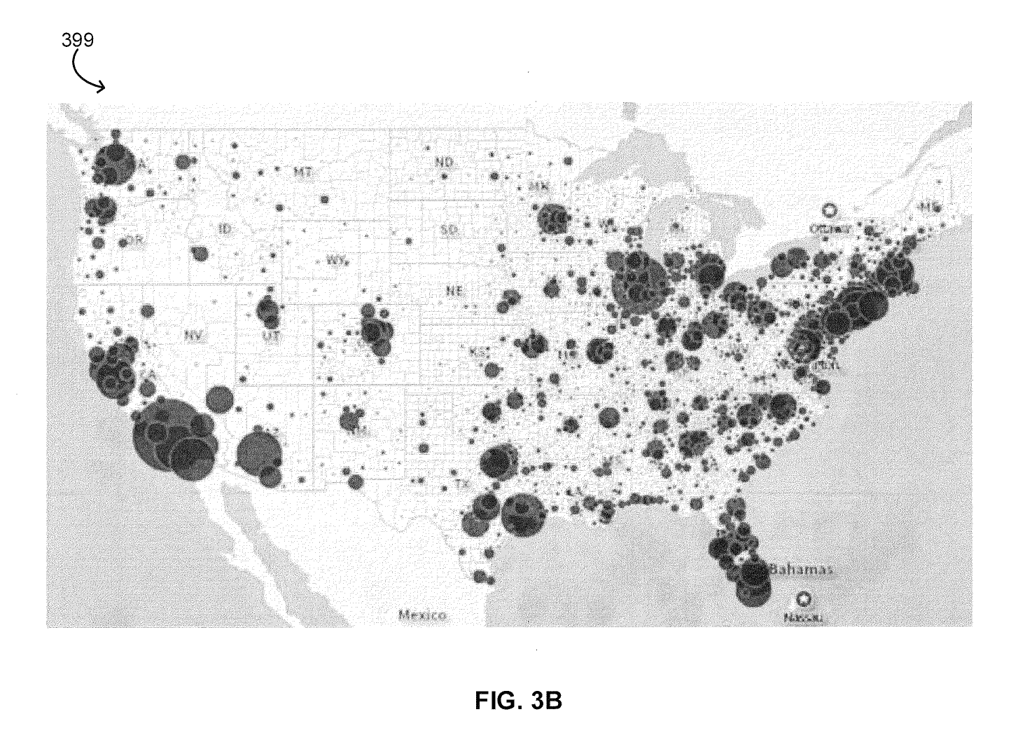

FIG. 3A provides a schematic illustrating a system 300 including the number of devices (e.g., the device 100, a device 202, a device 204, a device 206, and a device 208) in communication with the server system 200 in accordance with some embodiments.

As shown in FIG. 3A, the number of devices can be similar to the device 100. For example, the number of devices can be smart phones; however, the devices are not limited to smart phones, as any device including at least the elements of the device 100 are included such as tablet computers.

Again, the server-based auction module can be configured to auction to the one or more sponsors display-screen screen time in time frames leading into the future moments, during the present moments, or following past moments based upon one or more criteria including the individual or collective user interaction, one or more characteristics of the moments themselves, or a combination thereof.

The one or more criteria can include a collective intensity of the collective user interaction as algorithmically determined from client-based user-interaction-module data from touchscreen display-screen tapping on the number of devices (e.g., a number of mobile computing devices such as smart phones). The one or more criteria can additionally or alternatively include a collective intensity of the collective user interaction as algorithmically determined from sensor data from the number of devices, the sensor data from one or more sensors selected from accelerometers, gyroscopes, magnetometers, proximity sensors, light sensors, thermometers, air-humidity sensors, microphones, and cameras. The sensor data can include sensor data resulting from waving the number of devices, swinging the number of devices, shaking the number of devices, or a combination thereof.

The one or more criteria can additionally or alternatively include an amount of users in the collective user interaction as algorithmically determined from the number of devices such as a total number of the devices anywhere. The one or more criteria can additionally or alternatively include an amount of users in a particular location (e.g., stadium) in the collective user interaction as algorithmically determined from a number of unique global positioning system (“GPS”) coordinates such as shown in FIG. 3B.

The one or more criteria can include one or more characteristics of the moments themselves in relation to a particular group, a particular entertainer, a particular public figure, a particular team, a particular player, or a combination thereof. For example, the event can be a baseball game, and the one or more characteristics of the moments themselves can be a relation to a particular baseball team or baseball player (e.g., offensive player, defensive player, pitcher, batter, etc.) of the baseball game. The future moment for a first user can be a first batter of a first team on-deck awaiting a time at bat, the present moment can be a second batter of the first team at bat, and the past moment can be subsequent to a third batter of the first team getting a hit, hitting a home run, getting hit by a pitch, or striking out. (See, for example, the user interface 400A of FIG. 4A.) The future moment for a second user can also be a second pitcher of a second team warming up in the bullpen awaiting a time the mound, the present moment can be a first pitcher of the second team at the mound before a pitch, and the past moment can be the first pitcher of the second team at the mound after the pitch, optionally after walking or striking out a batter. (See, for example, the user interface 400B of FIG. 4B.) The event can alternatively be a football game, and the one or more characteristics of the moments themselves can be a relation to a play, a power play, a drive, a down, a touchdown, a catch, a long run, a sack, a goal-line stand, a penalty kick, or the like. The event can alternatively be a soccer game, and the one or more characteristics of the moments themselves can be a goal, a kick off, a penalty kick, a tackle, a sliding tackle, or the like. The event can alternatively be a basketball game, and the one or more characteristics of the moments themselves can be a relation to a field goal or “basket,” a three-pointer field goal, a slam dunk, an alley-oop, a rebound, an assist, or the like. The event can alternatively be a performance such as a concert performance, and the one or more characteristics of the moments themselves can be a relation to a start of a song, an end of a song, a demand by the audience for an encore, a start of an encore, an end of the concert performance, or the like. The event can alternatively be a political event such as a political speech, and the one or more characteristics of the moments themselves can be a relation to certain words spoken, certain concepts conveyed, certain topics, certain catch phrases spoken, or the like. The event can alternatively be an eSports game, and the one or more characteristics of the moments themselves can be a relation to one or more moments in the eSports game. Indeed, the event can be any event including, but not limited to, public events, private events, sporting events, and performances, and the one or more characteristics of the moments themselves can be a relation to any of the foregoing events.

The server-based user-interaction module can be configured to track user affiliations (e.g., team affiliation such as baseball or football team affiliation, political affiliation, etc.) in the one or more databases to present the one or more moments appropriately. For example, a first user affiliated with a baseball team in at bat can be presented with one or more moments for the team in at bat as shown in FIG. 4A, and a second user affiliated with a baseball team out in the field can be presented with one or more moments for the team out in the field including those with respect to pitching as shown in FIG. 4B.

Regarding interaction of the fan with the device 100, the interaction of the fan with the device 100 can include, but is not limited to, waving the device 100, swinging the device 100, tapping the touchscreen display screen of the device 100, or some combination thereof. An interactive visual element (e.g., a rally element [e.g., rally clapper] exemplified in FIGS. 4A and 4B) can be provided on the touchscreen display screen during the interaction of the fan. In some embodiments, the interactive element can be selected from a rally stick, a rally towel, and a rally clapper.

The interaction of the fan with the device 100 can include waving the device 100 when the interactive visual element is the rally stick. The user-interaction module can be further configured to log the interaction of the fan with the device 100 by logging data generated by the accelerometer, the gyroscope, or a combination thereof during the waving.

The interaction of the fan with the device 100 can include swinging the device 100 when the interactive visual element is a rally towel. The user-interaction module can be further configured to log the interaction of the fan with the device 100 by logging data generated by the accelerometer, the gyroscope, or a combination thereof during the swinging.

The interaction of the fan with the device 100 can include tapping the touchscreen display screen of the device 100 when the interactive visual element is the rally clapper. (See FIGS. 4A and 4B.) The user-interaction module can be further configured to log the interaction of the fan with the device 100 by logging data generated by the touchscreen display during the tapping.

Regarding the sponsor module, the sponsor module can be configured to enable a sponsor to brand the rally item with one or more brands of the sponsor; sponsor the entity ready to perform or the event ready to occur; and hold contests among up to all the fans of the entity ready to perform or the event ready to occur. Using tracked data in the one or more databases, the server-based award module can be configured to award one or more awards for the individual user interaction (e.g., waving the device 100, swinging the device 100, tapping the touchscreen display screen of the device 100, or some combination thereof) or the collective user interaction for any of the number of users, the one or more awards selected from points, rewards, and coupons.

Regarding the GPS module, the GPS module can be configured to calculate a geographical location of the device 100 from data received by the GPS receiver. The user-interaction module can be further configured to provide the geographical location of the device 100 to the one or more servers for geolocating up to all the fans of the entity ready to perform or the event ready to occur. FIG. 3B provides a map 399 illustrating geolocation of a number of devices and, therefore, a number of fans in accordance with some embodiments.

Regarding the network interface, the user-interaction module can be further configured to cooperate with the network interface for direct communication of one or more of the fans with the entity ready to perform.

Other features of the devices and methods provided herein can be better understood with reference to the following:

Fans can download an app including the user-interaction module on various smart phone platforms for free to rally for their favorite player or team when they are coming to the plate/mound or when it is close and late. The rally items can include a rally stick, a rally towel, or a rally clapper, each of which can be ordained with a logo of a sponsor. Additional rally items and ring tones can be available via in-app purchases, as well as mascots, player bobble heads, upgraded rally sticks, rally towels, and rally clappers for an additional “RallyBoost.” Fans can rally by waiving their phones back and forth or tapping their phones.

A sponsor can appear as the title sponsor on the rally towel, rally stick, or rally clapper, and have the option to sponsor one game, a block of games, or an entire season of games. Contests with sponsors are also allowed through the app. If a player hits a homerun, everyone who rallied for the player can get a free taco through a coupon issued through the app, a 10% discount coupon, etc.

The app can operate under a live in-game data feed indicating to fans when a player is coming to the plate, coming to the mound, hits a homerun or strikes out a batter to close a game out. Upon downloading the app, fans can select their favorite players to be notified about such as by opting in to notifications on their smart phones. With each pending selected event, whether each of the fans is sitting at his/her desk at work, at dinner with friends, or taking a nap, the fan can receive a notification: “It's Time to Rally!” In addition, fans can elect to be geolocated so that they can be “counted” on the main geolocation map (see FIG. 3B) shown at the stadium.

The app can be viewed as a mass social experiment in that the app can measure the effect fan participation has on the performance of sports stars, entertainer, etc.

The app can track the excitement and participation of a fan through first geolocating the fan anywhere on the globe as they are cheering their teams on, and then also measuring the kinetic energy created by the fan waving their smart phone in support of their team. The data can be collected, the amount of kinetic energy created can be consolidated, and the amount of kinetic energy can be translated into laymen's terms such as “enough kinetic energy to hit a baseball 5 miles,” “enough kinetic energy to throw a baseball at the speed of sound,” etc.

The kinetic energy can be calculated in accordance with the following equation:

Kinetic Energy(KE)=½ mass×velocity² or Eₖ=½ mv²

The app can used in any and all athletic events, entertainment events, and public events (e.g., political speeches).

The app can calculate, track, and collect an amount of kinetic energy created with a smart phone through “rallying” the phone in up-and-down motion.

The app can include a “solidarity mode,” which does not need to track the amount of kinetic energy. Rather, in solidarity mode, the app can track fans that are simultaneously holding their smart phones in various positions such as above their heads, etc.

The app can enable fantasy-sports interaction with players and their performances.

The app can enable geolocating fans so there can be interaction for players, teams, other fans, and sponsors/advertisers.

The app can enable direct communication between player, teams, and the like and their fans via video feed such as upon success of a rally, etc.

Collated results can be displayed on an in-stadium screen, website, or in the app itself.

The app can also provide the ability for players to incentivize personal support by giving awards weekly, monthly, or season-long for fans that support them the most: “Trip to Spring Training for the top 3 ralliers!”

The app can include a challenge system, which enables integration of the kinetic energy collected in the app with various video games, optionally further enabling competing against players live.

Rally events for fans can be tracked by the app and tallied throughout the season. Fans can see immediate feedback on how their support has affected the performance of their favorite players as shown in TABLE 1.

TABLE 1
Effect of fans' support on performance for their favorite players.

| STATS | BA | HR | RBI | OBP | SLG |
|---|---|---|---|---|---|
| 2015 | .271 | 25 | 85 | .309 | .813 |
| Season | | | | | |
| w/ your help | .313 | 10 | 16 | .342 | .938 |
| w/out you | .257 | 15 | 69 | .299 | .772 |

The app encourages fan participation in games outside of stadiums and allows for the first time, real individual geolocation data and how the data affects the fan experience. In addition, the data can show how each individual fan patronizes sponsors.

Geolocation can give players live information on where their fans are located, how loyal they are, who their “SuperFans” are for contests, and how much they directly support the sponsors through the app. Also, players can log in, set their rallying preferences such as creating a rally item and walk-up music for additional in-app revenue.

As fans open their app to rally for their favorite player or team, they can be geolocated and the kinetic energy created by waiving their smart phones can be stored and uploaded to a live geolocation map. The data feed can be made available through an application programming interface (“API”) for stadiums and their scoreboard screens, web sites, and the like to show current live national participation in the game.

FIG. 5 provides a schematic illustrating a device in accordance with some embodiments.

FIG. 5 illustrates a computing system 500 that can be, wholly or partially, part of one or more of the devices (e.g., one or more mobile computing devices) or one or more of the servers in accordance with some embodiments. With reference to FIG. 5, components of the computer system 500 can include, but are not limited to, a processing unit 520 having one or more processing cores, a system memory 530, and a system bus 521 that couples various system components including the system memory 530 to the processing unit 520. The system bus 521 can be any of several types of bus structures selected from a memory bus or memory controller, a peripheral bus, and a local bus using any of a variety of bus architectures.

Computer system 500 typically includes a variety of computer machine-readable media. Computer machine-readable media can be any available media that can be accessed by computer system 500 and includes both volatile and nonvolatile media, and removable and non-removable media. By way of example, and not limitation, computer machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, which can be subsequently accessed by the computer device 500. Transitory media such as wireless channels are not included in the machine-readable media. Communication media typically embody computer readable instructions, data structures, other executable software, or other transport mechanism and includes any information delivery media. As an example, some client computer systems on a network might not have optical or magnetic storage.

The system memory 530 includes computer storage media in the form of volatile and/or nonvolatile memory such as read only memory (ROM) 531 and random-access memory (RAM) 532. A basic input/output system 533 (BIOS) containing the basic routines that help to transfer information between elements within the computer system 500, such as during start-up, is typically stored in ROM 531. RAM 532 typically contains data and/or software that are immediately accessible to and/or presently being operated on by the processing unit 520. By way of example, and not limitation, FIG. 5 illustrates that RAM 532 can include a portion of the operating system 534, application programs 535, other executable software 536, and program data 537.

The computer system 500 can also include other removable/non-removable volatile/nonvolatile computer storage media. By way of example only, FIG. 5 illustrates a solid-state memory 541. Other removable/non-removable, volatile/nonvolatile computer storage media that can be used in the example operating environment include, but are not limited to, USB drives and devices, flash memory cards, solid state RAM, solid state ROM, and the like. The solid-state memory 541 is typically connected to the system bus 521 through a non-removable memory interface such as interface 540, and USB drive 551 is typically connected to the system bus 521 by a removable memory interface, such as interface 550.

The drives and their associated computer storage media discussed above and illustrated in FIG. 5, provide storage of computer readable instructions, data structures, other executable software and other data for the computer system 500. In FIG. 5, for example, the solid-state memory 541 is illustrated for storing operating system 544, application programs 545, other executable software 546, and program data 547. Note that these components can either be the same as or different from operating system 534, application programs 535, other executable software 536, and program data 537. Operating system 544, application programs 545, other executable software 546, and program data 547 are given different numbers here to illustrate that, at a minimum, they are different copies.

One or more non-transitory machine-readable storage media discussed above can have stored thereon a computer program comprising a set of computer readable instructions that cause a mobile computing device such as the device 100 to perform one or more steps when executed by one or more processors including, in some embodiments, displaying content on a touchscreen display screen of the device 100 and communicating with the server system 200. Displaying the content on the touchscreen display screen of the device 100 can include displaying by means of a client-based user-interaction module moment-related information and user-interaction information. The moment-related information can correspond to one or more moments in a performance of an entity, an occurrence of an event, or a combination thereof. The one or more moments can be selected from future moments, present moments, and past moments in the performance of the entity, the occurrence of the event, or the combination thereof. The user-interaction information can be configured to facilitate user interaction with the one or more moments. Displaying the content on the touchscreen display screen of the device 100 can also include displaying by means of a client-based sponsor module one or more sponsors of the performance of the entity, the occurrence of the event, or the combination thereof during the one or more moments. Communicating with the server system 200 can include communicating with a server-based user-interaction module and a server-based auction module stored in one or more non-volatile memories of the server system 200. The server-based user-interaction module upon execution by one or more processors of the server system 200 can be configured to track in one or more databases one or more individual user interactions received from the client-based user-interaction module. The server-based user-interaction module can also be configured to track in the one or more databases one or more additional user interactions for additional users of a number of like mobile computing devices (e.g., the device 202, the device 204, the device 206, and the device 208 of FIG. 3A) for a collective user interaction. The server-based auction module upon execution by the one or more processors of the server system 200 can be configured to auction to the one or more sponsors display-screen screen time on the device 100 in time frames leading into the future moments, during the present moments, or following past moments based upon one or more criteria. The one or more criteria can include one or more characteristics of the moments themselves, the individual user interactions, the collective user interaction, or a combination thereof.

The one or more non-transitory machine-readable storage media's set of instructions can further cause the mobile computing device such as the device 100 to perform one or more additional steps including displaying an award provided by means of a server-based award module. The server-based award module upon execution by the one or more processors of the server system 200 can be configured to award one or more awards for the one or more individual user interactions or a device-related portion of the collective user interaction received from the client-based user-interaction module. The one or more awards can be selected from points, rewards, and coupons.

A user can enter commands and information into the computer system 500 through input devices such as a keyboard, touchscreen, or software or hardware input buttons 562, a microphone 563, a pointing device and/or scrolling input component, such as a mouse, trackball or touch pad. The microphone 563 can cooperate with speech recognition software. These and other input devices are often connected to the processing unit 520 through a user input interface 560 that is coupled to the system bus 521, but these and other input devices can be connected by other interface and bus structures, such as a parallel port, game port, or a universal serial bus (USB). A display monitor 591 or other type of display screen device (e.g., touchscreen display screen) is also connected to the system bus 521 via an interface, such as a display interface 590. In addition to the monitor 591, computer devices can also include other peripheral output devices such as speakers 597, a vibrator 599, and other output devices, which can be connected through an output peripheral interface 595.

The computer system 500 can operate in a networked environment using logical connections to one or more remote computers/client devices, such as a remote computer system 580. The remote computer system 580 can a personal computer, a hand-held device, a server, a router, a network PC, a peer device or other common network node, and typically includes many or all of the elements described above relative to the computer system 500. The logical connections depicted in FIG. 5 can include a personal area network (PAN) 572 (e.g., Bluetooth®), a local area network (LAN) 571 (e.g., Wi-Fi), and a wide area network (WAN) 573 (e.g., cellular network), but can also include other networks such as a personal area network (e.g., Bluetooth®). Such networking environments are commonplace in offices, enterprise-wide computer networks, intranets and the Internet. A browser application can be resident on the computer device and stored in the memory.

When used in a LAN networking environment, the computer system 500 is connected to the LAN 571 through a network interface or adapter 570, which can be, for example, a Bluetooth® or Wi-Fi adapter. When used in a WAN networking environment (e.g., Internet), the computer system 500 typically includes some means for establishing communications over the WAN 573. With respect to mobile telecommunication technologies, for example, a radio interface, which can be internal or external, can be connected to the system bus 521 via the network interface 570, or other appropriate mechanism. In a networked environment, other software depicted relative to the computer system 500, or portions thereof, can be stored in the remote memory storage device. By way of example, and not limitation, FIG. 5 illustrates remote application programs 585 as residing on remote computer device 580. It will be appreciated that the network connections shown are examples and other means of establishing a communications link between the computer devices can be used.

As discussed, the computer system 500 can include a processor 520, a memory (e.g., ROM 531, RAM 532, etc.), a built-in battery to power the computer device, an AC power input to charge the battery, a display screen, a built-in Wi-Fi circuitry to wirelessly communicate with a remote computer device connected to network.

It should be noted that the present design can be carried out on a computer system such as that described with respect to FIG. 5. However, the present design can be carried out on a server, a computer device devoted to message handling, or on a distributed system in which different portions of the present design are carried out on different parts of the distributed computer system.

Another device that can be coupled to bus 521 is a power supply such as a DC power supply (e.g., battery) or an AC adapter circuit. As discussed above, the DC power supply can be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computer device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

The foregoing represents an advance in technology for greater fan interaction, team/player loyalty, and sponsor participation, which is rooted in computer-related technology in order to overcome a technical problem thereof.

While the foregoing concepts and embodiments thereof have been provided in considerable detail, it is not the intention of the applicant(s) for the concepts and embodiments provided herein to be limiting. Additional adaptations and/or modifications are possible, and, in broader aspects, these adaptations and/or modifications are also encompassed. Accordingly, departures can be made from the foregoing concepts and embodiments without departing from the scope afforded by the following claims, which scope is only limited by the claims when appropriately construed.

What is claimed is:

1. A system, comprising:
a client-based user-interaction module and a client-based sponsor module stored in one or more non-volatile memories of at least one mobile computing device,
wherein the client-based user-interaction module upon execution by one or more processors of the at least one device is configured to display on a touchscreen display screen of the at least one device
moment-related information corresponding to one or more moments selected from future moments, present moments, and past moments in a performance of an entity, an occurrence of an event, or a combination thereof, and
user-interaction information configured to facilitate user interaction with the one or more moments, and
wherein the client-based sponsor module upon execution by the one or more processors of the at least one device is configured to display on the display screen one or more sponsors of the performance of the entity, the occurrence of the event, or the combination thereof during the one or more moments; and
a server-based user-interaction module and a server-based auction module stored in one or more non-volatile memories of a server system,
wherein the server-based user-interaction module upon execution by one or more processors of the server system is configured to track in one or more databases an individual user interaction for up to each of a number of users and a collective user interaction for up to a total number of the users, and
wherein the server-based auction module upon execution by the one or more processors of the server system is configured to auction to the one or more sponsors display-screen screen time in time frames leading into the future moments, during the present moments, or following past moments based upon one or more criteria including one or more characteristics of the moments themselves, the individual or collective user interaction, or a combination thereof.

2. The system of claim 1, further comprising:
a server-based award module,
wherein the server-based award module upon execution by the one or more processors of the server system is configured to award one or more awards for the individual user interaction or the collective user interaction for any of the number of users, the one or more awards selected from points, rewards, and coupons.

3. The system of claim 1,
wherein the one or more criteria include a collective intensity of the collective user interaction as algorithmically determined from client-based user-interaction-module data from touchscreen display-screen tapping on a number of mobile computing devices.

4. The system of claim 1,
wherein the one or more criteria include a collective intensity of the collective user interaction as algorithmically determined from sensor data from a number of mobile computing devices, and
wherein the sensor data from one or more sensors is selected from accelerometers, gyroscopes, magnetometers, proximity sensors, light sensors, thermometers, air-humidity sensors, microphones, and cameras.

5. The system of claim 4,
wherein the sensor data includes sensor data resulting from waving the number of devices, swinging the number of devices, shaking the number of devices, or a combination thereof.

6. The system of claim 1,
wherein the one or more criteria include a collective intensity of the collective user interaction as algorithmically determined from client-based user-interaction-module data from touchscreen display-screen tapping on a number of mobile computing devices, sensor data from the number of devices, or a combination thereof, and
wherein the sensor data is from one or more sensors selected from accelerometers, gyroscopes, magnetometers, proximity sensors, light sensors, thermometers, air-humidity sensors, microphones, and cameras resulting from waving the number of devices, swinging the number of devices, shaking the number of devices, or a combination thereof.

7. The system of claim 1,
wherein the one or more criteria include an amount of users in the collective user interaction as algorithmically determined from a number of mobile computing devices.

8. The system of claim 7,
wherein the one or more criteria include an amount of users in a particular location in the collective user interaction as algorithmically determined from a number of unique global positioning system (“GPS”) coordinates.

9. The system of claim 1,
wherein the one or more characteristics of the moments themselves is a relation to a particular group, a particular entertainer, a particular public figure, a particular team, a particular player, or a combination thereof.

10. The system of claim 1,
wherein the event is a baseball game, a football game, a soccer game, a basketball game, a concert performance, or a political speech.

11. The system of claim 1,
wherein the event is a baseball game and the one or more moments are selected from any offensive-player moment and any defensive player moment.

12. The system of claim 1,
wherein the event is a baseball game, the future moment is a first batter on-deck awaiting a time at bat, the present moment is a second batter at bat, and the past moment is subsequent to a third batter getting a hit, hitting a home run, getting hit by a pitch, or striking out.

13. The system of claim 1,
wherein the event is a football game and the one or more moments are selected from a play, a power play, a drive, a down, a touchdown, a catch, a long run, a sack, a goal-line stand, and a penalty kick.

14. The system of claim 1,
wherein the event is a soccer game and the one or more moments are selected from a goal, a kick off, a penalty kick, a tackle, and a sliding tackle.

15. The system of claim 1,
wherein the event is a basketball game and the one or more moments are selected from a field goal, a three-pointer field goal, a slam dunk, an alley-oop, a rebound, and an assist.

16. The system of claim 1,
wherein the event is a concert performance and the one or more moments are selected from a start of a song, an end of a song, a demand by the audience for an encore, a start of an encore, and an end of the concert performance.

17. The system of claim 1,
wherein the event is a political speech and the one or more moments are selected from certain words spoken, certain concepts conveyed, certain topics, and certain catch phrases spoken.

18. A non-transitory machine-readable storage medium having stored thereon a computer program comprising a set of instructions that cause a mobile computing device to perform one or more steps when executed by one or more processors, comprising:
displaying on a touchscreen display screen of the device by means of a client-based user-interaction module
moment-related information corresponding to one or more moments selected from future moments, present moments, and past moments in a performance of an entity, an occurrence of an event, or a combination thereof, and
user-interaction information configured to facilitate user interaction with the one or more moments;
displaying on the display screen of the device by means of a client-based sponsor module one or more sponsors of the performance of the entity, the occurrence of the event, or the combination thereof during the one or more moments; and
communicating with a server system including a server-based user-interaction module and a server-based auction module stored in one or more non-volatile memories of the server system,
wherein the server-based user-interaction module upon execution by one or more processors of the server system is configured to track in one or more databases one or more individual user interactions received from the client-based user-interaction module and one or more additional user interactions for additional users of a number of like mobile computing devices for a collective user interaction, and
wherein the server-based auction module upon execution by the one or more processors of the server system is configured to auction to the one or more sponsors display-screen screen time on the device in time frames leading into the future moments, during the present moments, or following past moments based upon one or more criteria including one or more characteristics of the moments themselves, the individual user interactions, the collective user interaction, or a combination thereof.

19. The storage medium of claim 18, further comprising:
displaying an award provided by means of a server-based award module,
wherein the server-based award module upon execution by the one or more processors of the server system is configured to award one or more awards for the one or more individual user interactions or a device-related portion of the collective user interaction received from the client-based user-interaction module, the one or more awards selected from points, rewards, and coupons.

20. The storage medium of claim 18,
wherein the one or more criteria include a collective intensity of the collective user interaction as algorithmically determined from client-based user-interaction-module data from touchscreen display-screen tapping on the number of like mobile computing devices including the display screen of the device.

21. The storage medium of claim 18,
wherein the one or more criteria include a collective intensity of the collective user interaction as algorithmically determined from sensor data from the number of like mobile computing devices including the device, and
wherein the sensor data is from one or more sensors selected from accelerometers, gyroscopes, magnetometers, proximity sensors, light sensors, thermometers, air-humidity sensors, microphones, and cameras.

22. The storage medium of claim 21,
wherein the sensor data includes sensor data resulting from waving, swinging, or shaking the number of like mobile computing devices including the device, or a combination thereof.

23. The storage medium of claim 18,
wherein the one or more criteria include a collective intensity of the collective user interaction as algorithmically determined from client-based user-interaction-module data from touchscreen display-screen tapping on the number of like mobile computing devices including the device, sensor data from the number of devices, or a combination thereof, and
wherein the sensor data is from one or more sensors selected from accelerometers, gyroscopes, magnetometers, proximity sensors, light sensors, thermometers, air-humidity sensors, microphones, and cameras resulting from waving, swinging, or shaking the number of like mobile computing devices including the device, or a combination thereof.

24. The storage medium of claim 18,
wherein the one or more criteria include an amount of users in the collective user interaction as algorithmically determined from the number of like mobile computing devices including the device.

25. The storage medium of claim 18,
wherein the one or more criteria include an amount of users in a particular location in the collective user interaction as algorithmically determined from a number of unique global positioning system (“GPS”) coordinates.

26. The storage medium of 18,
wherein the one or more characteristics of the moments themselves is a relation to a particular group, a particular entertainer, a particular public figure, a particular team, a particular player, or a combination thereof.

27. The storage medium of claim 18,
wherein the event is a baseball game, a football game, a soccer game, a basketball game, a concert performance, or a political speech.

28. The storage medium of claim 18,
wherein the event is a baseball game and the one or more moments are selected from any offensive-player moment and any defensive player moment.

29. The storage medium of claim 18,
wherein the event is a baseball game, the future moment is a first batter on-deck awaiting a time at bat, the present moment is a second batter at bat, and the past moment is subsequent to a third batter getting a hit, hitting a home run, getting hit by a pitch, or striking out.

30. The storage medium of claim 18,
wherein the event is a football game and the one or more moments are selected from a play, a power play, a drive, a down, a touchdown, a catch, a long run, a sack, a goal-line stand, and a penalty kick.

31. The storage medium of claim 18,
wherein the event is a soccer game and the one or more moments are selected from a goal, a kick off, a penalty kick, a tackle, and a sliding tackle.

32. The storage medium of claim 18,
wherein the event is a basketball game and the one or more moments are selected from a field goal, a three-pointer field goal, a slam dunk, an alley-oop, a rebound, and an assist.

33. The storage medium of claim 18,
wherein the event is a concert performance and the one or more moments are selected from a start of a song, an end of a song, a demand by the audience for an encore, a start of an encore, and an end of the concert performance.

34. The storage medium of claim 18,
wherein the event is a political speech and the one or more moments are selected from certain words spoken, certain concepts conveyed, certain topics, and certain catch phrases spoken.
